(19) United States
(12) Patent Application Publication
(10) Pub. No.: US 2007/0016767 A1
(43) Pub. Date: Jan. 18, 2007

(54) Switching Devices Avoiding Degradation of Forwarding Throughput Performance When Downloading Signature Data Related to Security Applications

(75) Inventors: Seenu Banda, Sunnyvale, CA (US); Robert Matthew Haragan Jr., Los Altos, CA (US)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: NETDEVICES, INC., Sunnyvale, CA (US)

(21) Appl. No.: 11/160,666

(22) Filed: Jul. 5, 2005

(51) Int. Cl. H04L 9/00

(52) U.S. Cl. 713/153

(57) ABSTRACT

Using one set of processors for downloading (and associated processing of) signature data corresponding to security application, and using another set of processors for forwarding/switching. The associated processing may include decompression of the data, authentication (hash computation and verification). Due to the use of separate processors for signature downloads, the forwarding throughput performance of a switching device (e.g., gateway/router) may not be impeded at least substantially during signature data download. Similarly, an out-of-band connection can also optionally be used for signature download.

### BACKGROUND OF THE INVENTION

1. Field of the Invention

The present invention relates generally to switching devices (e.g., routers and gateways) used in networking environments, and more specifically to a method and apparatus for avoiding throughput performance degradation when downloading signature data related to security applications in such devices.

2. Related Art

Switching devices are employed in networking environments to receive data on one interface and forward the received data on another interface. Internet Protocol (IP) router is an example of such switching device, and generally bases the forwarding decisions (specific interface to forward on) on the destination address contained in each received packet.

Security applications are often implemented in switching devices, generally since the switches are in many communication paths (or virtual circuits). Examples of such security applications include anti-virus programs (which generally protect end systems/routers from virus programs) and intrusion detection systems (which detect/prevent unauthorized external programs from learning various configurations or status information in end systems, routers, etc.), well known in the relevant arts. By implementing the security applications on switching devices, security threats can potentially be detected, defended and/or prevented since information from packets on several communication paths is available in switching devices.

There are several security applications which use signatures. Signatures generally represent the specific data patterns which pose a corresponding security threat. Signatures provide a convenient mechanism to specify/indicate any newly discovered (uncovered) security threats. Typically, vendors identify any newly introduced security threats (by malicious third parties) and provide signatures to specify the corresponding data pattern to detect such identified security threat(s).

The signature (or updates/additions/deletions thereto) data is often made available in a central server accessible over Internet. Accordingly, the signature data is downloaded to each switching device of interest. In general, it is desirable that the forwarding throughput performance (e.g., number of bytes/packets forwarded in unit time) of the switching device not deteriorate while such download is being performed. Performance deterioration is of particular concern as the amount of signature data (or file in which the data is provided) continues to become large, as is seen as the trend at least in some environments.

Accordingly what is needed is a method and apparatus for avoiding throughput performance degradation when downloading signature data related to security applications in such devices.

### BRIEF DESCRIPTION OF THE DRAWINGS

The present invention will be described with reference to the accompanying drawings, which are described below briefly. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an example environment in which various aspects of the present invention can be implemented.

FIG. 2 is a block diagram illustrating the manner in which a security application operates using signatures in one embodiment.

FIG. 3 is a block diagram illustrating the details of a switching device in an embodiment of the present invention.

FIG. 4 is a block diagram illustrating the details of processing of packets by network services executing in a switching device in one embodiment.

FIG. 5 is a block diagram illustrating the details of an embodiment of a digital processing system in which various aspects of the present invention are operative by execution of appropriate software instructions.

### DETAILED DESCRIPTION OF THE PREFERRED EMBODIMENTS

1. Overview and Discussion of the Invention

A switching device provided according to an aspect of the present invention uses one set of processors to forward packets (to provide switching) and another set of processors to download signature data. Due to the use of separate processors for forwarding and signature downloads, the forwarding throughput performance of the switching devices may not be degraded during signature downloads.

In an embodiment, the scan operations (i.e., examining packets for match with signatures represented by the signature data) are also conveniently provided by the same set of processors performing the forwarding operation. As a result, the rate at which scan operations are completed, may also not be affected substantially by the signature downloads, thereby also avoiding forwarding throughput performance degradation.

According to another aspect of the present invention, a separate (i.e., not shared by the interfaces between which switching operation is performed) bandwidth link is provided for signature downloads. Due to the use of such separate bandwidth link, forwarding throughput performance may not be affected by signature downloads.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

2. Example Environment

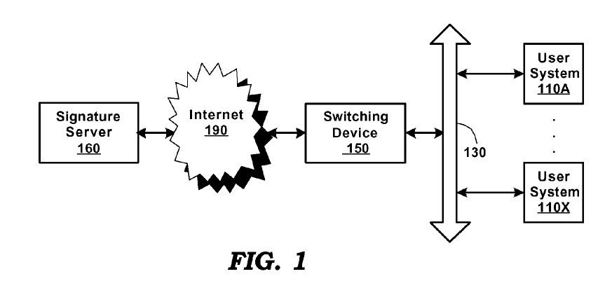

FIG. 1 is a block diagram illustrating the details of an example environment in which various aspects of the present invention can be implemented. The environment is shown containing user systems 110A-110X, local-area-network (LAN) 130, switching device 150, signature server 160 and Internet 190. It is assumed that user systems 110A-110X, local-area-network (LAN) 130 and switching device 150 are located within an enterprise. Each block is described in further detail below.

User systems 110A-110X represent devices, which can be used to access various data and services using Internet 190 via LAN 130. Internet 190 contains various routers/gateways which enable communication between systems on the world-wide-web and user systems 110A-110X using Internet Protocol, in a known way. LAN 130 may also be implemented using IP (and Ethernet), and provide communication between user system within the enterprise, as well as with external systems.

Signature server 160 stores data representing various signatures used by security applications. The signatures can represent the entire set and/or updates to previous provided sets. The signature data can be downloaded by various devices implementing the corresponding applications.

Switching device 150 forwards packets from one interface to other, and also implements various security applications. In embodiment(s) described below, switching device 150 is assumed to operate consistent with Internet Protocol. The security applications may use signatures, and various aspects of the present invention ensure that the forwarding throughput performance of switching device 150 is not degraded when the signature data is downloaded, as described below with examples in further detail. It is first helpful to appreciate example causes for performance degradation.

3. Sources for Performance Degradation

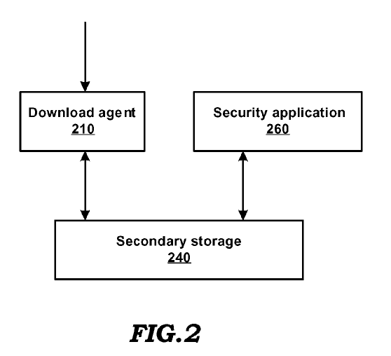

FIG. 2 is a block diagram used to illustrate example causes for degradation of forwarding throughput performance. The block diagram is shown containing signature download agent 210, secondary storage 240 and security application 260. Each block is described below in further detail.

Security application 260 retrieves data representing (consolidated) signatures available in secondary storage 240 (at the time of initialization), scans packets (being forwarded/switched) for match with the signatures, and performs a desired action upon match (or absence of match) as specified by the configuration data (specified by an administrator), program logic and signature data. Security application 260 corresponds to anti-virus program or intrusion detection system in one embodiment.

Download agent 210 downloads signature data from signature server 160, and updates the consolidated signatures according to the received data. Various approaches well known in the relevant arts can be used for such update operations. The consolidated signatures may then be stored in secondary storage 240, as well as provided to security application 260.

In one embodiment, two directories are provided (in a random access memory), with one directory being used for the copy of the consolidated signatures from which security application 260 presently operates. Download agent 210 stores a new version of the consolidated signatures in the other directory, and notifies (e.g., by an interrupt and providing a pointer to the memory location where the directory starts) security application 260 to switch to operation from the signature data in the other directory. Thus, the two directories can be used to seamlessly switch to operation to later versions of the signature data.

However, download agent 210 may require substantial computational resources. The signature data may be received in compressed format (to minimize the size of the data downloaded from signature server 160, in addition to providing security). Decompression of the data generally requires processing resources.

In addition, to address (or avoid) concerns such as spoofing by third parties (or authentication, in general), a hash may also be received associated with the signature data. As is well known, the hash needs to be independently computed from the received signature data and compared with the received hash to ensure the integrity of the received signature data. The computation of hash could also require substantial resources, particularly as the amount of signature data grows to large size.

Post-processing of the decompressed (authenticated) data may require additional resources. For example, generating the consolidate signatures from the received signature data may require additional processing resources.

Due to the computational resources (such as those described above), the forwarding throughput performance of switching devices may be impacted if there is substantial overlap in the processors used for forwarding/scanning as well as signature download. Based on such a recognition, various aspects of the present invention may ensure that the forwarding throughput performance is not impeded due to the signature downloads, as described below in further detail.

4. Hardware Architecture of Switching device

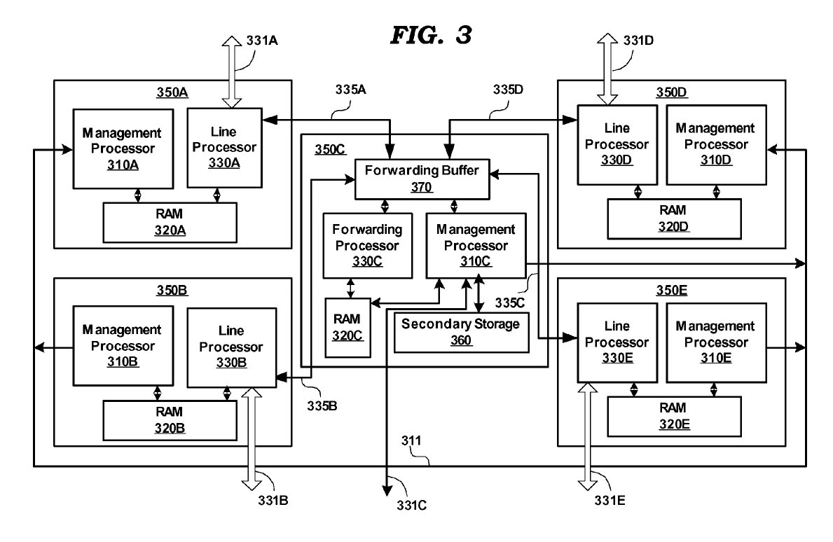

FIG. 3 illustrates the details of switching device 150 in one embodiment. Switching device 150 is shown containing management processors 310A-310E, management memories (RAM) 320A-320E, line processors 330A, 330B, 330D, and 330E, forwarding processor 330C, secondary storage 360, and forwarding buffer 370. The management processors are shown connected by management bus 311, and line processors 330A, 330B, 330D and 330E are shown connected via forwarding processor 330C.

Each pair of a management processor and forwarding processor may be contained in a corresponding card. Thus cards 350A, 350B, 350D and 350E are respectively shown containing {management processor 310A and line processor 330A}, {management processor 310B and line processor 330B}, {management processor 310D and line processor 330D},{management processor 310E and forwarding processor 330E}. Thus, forwarding of packets across cards occurs via card 350C (and is referred to as a main processing system), while forwarding buffer 370 is used to store packets between the forwarding operations.

In an embodiment, each forwarding processor is implemented using Opteron (™ ) processor available from Advanced Micro Devices Inc., One AMD Place, Sunnyvale, Calif. 94088, Phone: (408) 749-4000, each management processor is implemented using IXP processor available from Intel Corporation, and the line processor depends on the specific type of connection (e.g., Mindspeed corporation for T1 interface, Marvel Corporation for Ethernet). The management processors are shown connected by Ethernet bus 311, while the line processors are connected to forwarding processor 330C by corresponding PCI Express Interface (335A-335D), well known in the relevant arts.

Broadly, each line processor receives data to be routed/switched on a corresponding interface(s) (e.g., T3, Ethernet, etc., as shown by corresponding bidirectional path), and stores the corresponding packet in forwarding buffer 370. Forwarding processor 330C determines the specific line card on which to forward each packet stored in forwarding buffer 370. In addition, forwarding processor 330C may implement various features such as security applications, NAT, firewall, IPSec, VolP, in conjunction with the forwarding operation. The forwarding decisions are generally based on various forwarding tables (e.g., routing table in the case of IP). Each packet is then transmitted by the corresponding line processor.

Management processors 310A-310E facilitate the management of various services (e.g., by executing the feature servers, described in detail below) and hardware, as well as setting up some of the tables used by forwarding processors. However, broadly, management processors 310A-310E provide various management features, health monitoring of services, notification, time stroke alerts, logging, etc., (requiring high reliability).

Only the details of management/line/forwarding processors as relevant to an understanding of the features of the present invention are described in detail in this document. For further details, the reader is referred to co-pending US patent applications bearing ser. No. 10/950253, entitled, “System and Method for Enabling Management Functions in a Network”, filed: Sep. 27, 2004, and ser. No. 11/060199, entitled, “System and Method for Enabling Redundancy in PCI-Express Architecture”, filed: Feb. 17, 2005, (both having the assignees of the subject application as a common assignee) which are both incorporated in their entirety herewith.

As relevant to the present application, management processor 310C operates to download signatures (for the security applications implemented by forwarding processor 330C) and cause the security application to operate from the updated consolidated signatures. In other words, management processor 310C implements download agent 210 (for decompression, hash computation, download operation) described above, forwarding processor 330C implements corresponding security application 260, RAM 320C supports the directories (for storing signatures) described above, and secondary storage 360 is used similar to secondary storage 240.

Due to the use of one set of processors (310C in the above example) for signature download/processing and another set of processors (330C) for forwarding (including scanning according to signatures to detect matching packets/patterns), the forwarding throughput performance may not at least be substantially impeded by signature download/processing.

In one embodiment, one or more communication paths 331A, 331B, 331D and 331E are used for signature downloads. As may be appreciated, these communications paths are used for forwarding/receiving data packets that need to be switched/routed. One problem with such an approach is that the demands on the available bandwidth on these communication paths, may impede the forwarding throughput performance of switching device 150.

Thus, according to another aspect of the present invention, a separate communication path 331C is used for downloading of signature data alone (i.e., as an out-of-band communication channel). For example, an on-demand channel (e.g., dial-up) can be used for path 331C, and management processor 310C can download signature data on path 331C. It should be appreciated that path 331C can terminate on any of management processors 310A-310E since the processors operate as a cluster in the described embodiment(s). The downloaded data can then be decompressed/authenticated and uploaded to security application 260, as described above.

It should be appreciated that the security application thus described can be implemented in various environments. The description is continued with respect to a software architecture.

5. Example Software Architecture

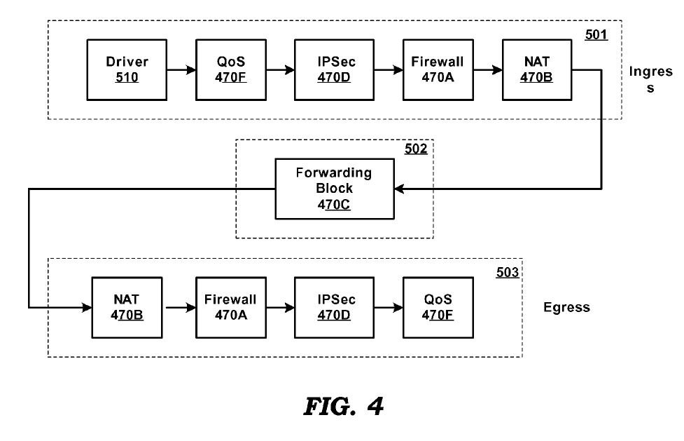

FIG. 4 is a block diagram illustrating the manner in which a security application provided as above may interoperate with various services in an embodiment of the present invention. As shown there, the services may broadly operate in three phases—(1) ingress processing 401; (2) forwarding processing 402; and (3) egress processing 403. Each of the services may operate individually in both ingress processing and egress processing (associated with each interface/port), and forwarding processing is shared by all the services together. Thus, each of ingress processing 401 and egress processing 403 is shown containing QoS block 420, security application 430, firewall 440 and network address translation block 450.

With respect to ingress processing 401, a packet received by driver 410 of a line processor is first processed by QoS service 420. Packets requiring higher priority are marked accordingly (by QoS service 420), and subsequent services process such packets with a higher priority. In this embodiment, it is assumed that there are only two priorities such that the higher priority packets (marked as such) are selected for processing ahead of other waiting packets by each subsequent service. The priority aspect is not described expressly in other services, as the corresponding processing may otherwise (i.e., other than sequence of selection) be the same for both high and low priority packets.

After QoS service 420, each packet is processed by security service 430. In an embodiment, security service 430 corresponds to intrusion detection system (IDS), and can be implemented in a known way. The signatures required for IDS are downloaded by separate processor(s) and/or separate communication paths as described above, and IDS operates using the updated signatures. In general, the signatures specify corresponding patterns, and the processed packets are scanned for match with the patterns. An action (e.g., logging information corresponding to a match on a secondary storage) specified with the matches may be performed.

Firewall service 440 processes packets received from security service. In general, firewall contains data specifying filtering criteria, and some of the packets may not be forwarded (dropped). The filtering criteria may include prevention of any denial of service (DOS) attacks, etc. It should be appreciated that security service 430 can be implemented after firewall service 440 in alternative embodiments. NAT block 450 performs any required NAT operation for the corresponding interface.

Forwarding block 470 determines the specific interface on which to forward each packet. The forwarding decision is generally based on tables setup using routing protocols (such as OSPF, BGP, RIP, well known in the relevant arts). Forwarding block 470, NAT block 450 and firewall service 440 can be implemented in a known way.

The operation of each of these services in egress processing 403 is similarly described. Depending on the configuration for the corresponding output interface/port on which a packet is being forwarded, each service performs a corresponding processing (consistent with the configuration). QoS service 470F causes transmission of high priority packets in out-of-sequence (ahead of lower priority packets). Thus, by the operation of all these services cooperatively within network device 150, packets may be switched as desired.

It should be appreciated that the features described above may be implemented in various combinations of hardware, software and firmware, depending on the corresponding requirements. The description is continued with respect to an embodiment in which the features are operative upon execution of the corresponding software instructions.

6. Software Implementation

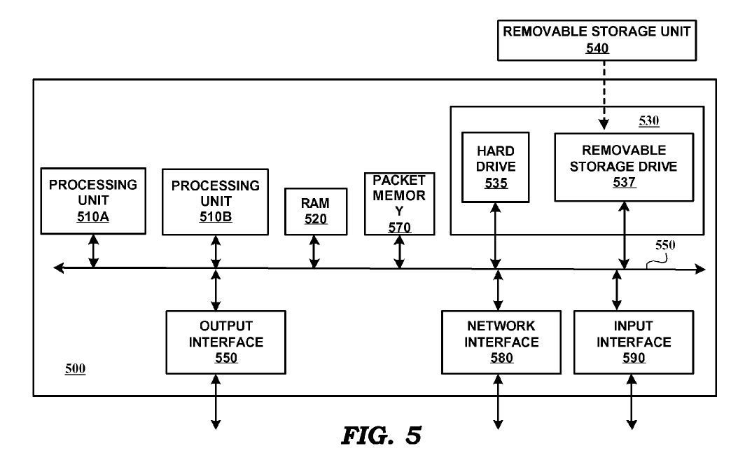

FIG. 5 is a block diagram illustrating the details of digital processing system 500 in one embodiment. System 500 may correspond to network device 150. System 500 is shown containing processing units 510A and 510B, random access memory (RAM) 520, secondary memory 530, output interface 560, packet memory 570, network interface 580 and input interface 590. Each component is described in further detail below.

Input interface 590 (e.g., interface with a key-board and/or mouse, not shown) enables a user/administrator to provide any necessary inputs to system 500. Output interface 560 provides output signals (e.g., display signals to a display unit, not shown), and the two interfaces together can form the basis for a suitable user interface for an administrator to interact with system 500.

Network interface 580 may enable system 500 to send/receive data packets to/from other systems on corresponding paths using protocols such as internet protocol (IP). Network interface 580, output interface 560 and input interface 590 can be implemented in a known way.

RAM 520 (supporting memory 560), secondary memory 530 (e.g., used in some respects similar to 240), and packet memory 570 (similar to 370) may together be referred to as a memory. RAM 520 receives instructions and data on path 550 (which may represent several buses) from secondary memory 530, and provides the instructions to processing units 510A and 510B for execution.

Packet memory 570 stores (queues) packets waiting to be forwarded (or otherwise processed) on different ports/interfaces. Secondary memory 530 may contain units such as hard drive 535 and removable storage drive 537. Secondary memory 530 may store the software instructions and data, which enable system 500 to provide several features in accordance with the present invention.

Some or all of the data and instructions may be provided on removable storage unit 540 (or from a network using protocols such as Internet Protocol), and the data and instructions may be read and provided by removable storage drive 537 to processing units 510A/510B. Floppy drive, magnetic tape drive, CD-ROM drive, DVD Drive, Flash memory, removable memory chip (PCMCIA Card, EPROM) are examples of such removable storage drive 537.

Each processing unit 510A and 510B may contain one or more processors. Some of the processors can be general purpose processors which execute instructions provided from RAM 520. Some can be special purpose processors adapted for specific tasks (e.g., for memory/queue management). The special purpose processors may also be provided instructions from RAM 520.

As relevant to the features of the present invention, processing unit 510A may be used for switching services, and processing unit 510B may be used for signature downloads and associated processing. In general, processing units 510A and 510B reads sequences of instructions from various types of memory medium (including RAM 520, storage 530 and removable storage unit 540), and executes the instructions to provide various features of the present invention described above.

### 7. CONCLUSION

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A switching device executing a security application, wherein said security application requires a plurality of signatures to determine a plurality of matching patterns to perform corresponding desired operations, said switching device comprising:
a plurality of interfaces to receive a plurality of packets;
a first set of processors to determine a specific one of said plurality of interfaces to send each of said plurality of packets to, wherein each packet is transmitted on the determined one of said plurality of interfaces; and
a second set of processors decompressing a signature data, wherein the decompressed data is used to update said plurality of signatures,
wherein the throughput performance of said first set of processors is not impeded due to the use of a separate set of processors for decompressing said signature data.

2. The switching device of claim 1, wherein said second set of processors compute a hash value of said signature data, wherein said computed hash value is compared with a received hash value.

3. The switching device of claim 1, wherein said security application comprises one of intrusion detection system and anti-virus software.

4. The switching device of claim 1, wherein said first set of processors also scan said plurality of packets for match with any of said plurality of signatures.

5. The switching device of claim 1, wherein each of said plurality of interfaces is coupled to a corresponding communication path, wherein said signature data is downloaded from an external server on a separate communication path terminating on one of said second set of processors.

6. The switching device of claim 5, wherein said separate communication path is established on-demand when said signature data is to be downloaded.

7. The switching device of claim 6, wherein said separate communication path comprises a dial-up connection.

8. A computer readable medium carrying one or more sequences of instructions for causing a network device to provide services in an inter-networked environment, wherein execution of said one or more sequences of instructions by a plurality of processors contained in said network device causes said one or more processors to perform the actions of:
receiving a plurality of packets on a plurality of interfaces;
determining a specific one of said plurality of interfaces to send each of said plurality of packets using a first set of processors, wherein each packet is transmitted on the determined one of said plurality of interfaces; and
decompressing a signature data using a second set of processors, wherein the decompressed data is used to update said plurality of signatures,
wherein said first set of processors and said second set of processors are contained in said plurality of processors,
wherein the throughput performance of said first set of processors is not impeded due to the use of a separate set of processors for decompressing said signature data.

9. The computer readable medium of claim 8, further comprising computing a hash value of said signature data using said second set of processors, wherein said computed hash value is compared with a received hash value.

10. The computer readable medium of claim 8, wherein said security application comprises one of intrusion detection system and anti-virus software.

11. The computer readable medium of claim 8, further comprising scanning said plurality of packets for match with any of said plurality of signatures using said first set of processors.

12. The computer readable medium of claim 8, wherein each of said plurality of interfaces is coupled to a corresponding communication path, further comprising downloading said signature data from an external server on a separate communication path terminating on one of said second set of processors.

13. The computer readable medium of claim 12, wherein said separate communication path is established on-demand when said signature data is to be downloaded.

14. The computer readable medium of claim 13, wherein said separate communication path comprises a dial-up connection.

15. A method of supporting the execution of a security application, wherein said security application requires a plurality of signatures to determine a plurality of matching patterns to perform corresponding desired operations, said method comprising:
receiving a plurality of packets on a plurality of interfaces;
determining a specific one of said plurality of interfaces to send each of said plurality of packets using a first set of processors, wherein each packet is transmitted on the determined one of said plurality of interfaces; and
decompressing a signature data using a second set of processors, wherein the decompressed data is used to update said plurality of signatures,
wherein said first set of processors and said second set of processors are contained in said plurality of processors,
wherein the throughput performance of said first set of processors is not impeded due to the use of a separate set of processors for decompressing said signature data.

16. The method of claim 15, further comprising computing a hash value of said signature data using said second set of processors, wherein said computed hash value is compared with a received hash value.

17. The method of claim 15, wherein said security application comprises one of intrusion detection system and anti-virus software.

18. The method of claim 15, further comprising scanning said plurality of packets for match with any of said plurality of signatures using said first set of processors.

19. The method of claim 15, wherein each of said plurality of interfaces is coupled to a corresponding communication path, further comprising downloading said signature data from an external server on a separate communication path terminating on one of said second set of processors.

20. The method of claim 19, wherein said separate communication path is established on-demand when said signature data is to be downloaded.
